(19) United States
(12) Patent Application Publication
(10) Pub. No.: US 2008/0300922 A1
(43) Pub. Date: Dec. 4, 2008

(54) Electronic medical documentation

(75) Inventors: Donald Forgue, Kansas City, MO (US); Andrew Slaughter, Kansas City, MO (US)

Correspondence Address: HOVEY WILLIAMS LLP, 10801 Mastin Blvd., Suite 1000, Overland Park, KS, 66210, US

(73) Assignee: The Children's Mercy Hospital, Kansas City, MO (US)

(21) Appl. No.: 12/079,208

(22) Filed: Mar. 25, 2008

Related U.S. Application Data
(60) Provisional application No. 60/941,553, filed on Jun. 1, 2007.

(51) Int. Cl. G06Q 50/00; G06F 17/30

(52) U.S. Cl. 705/3

(57) ABSTRACT

A system for electronic medical documentation receives a patient identifier and patient healthcare information from a user, associates the patient healthcare information with the patient identifier, and stores the patient healthcare information in an intermediate database. The system receives a command from the user and, upon receipt of the command, communicates the patient healthcare information from the intermediate database to an electronic medical record database according to a protocol that enables the electronic medical record database to store the patient healthcare information as a caregiver note in an electronic medical record pertaining to the patient identifier. The intermediate database may include patient information received from the electronic medical record database and relating only to current patients, and may be stored on a wireless handheld computing device.

### RELATED APPLICATIONS

The present application is a nonprovisional patent application and claims priority benefit, with regard to all common subject matter, of earlier-filed U.S. provisional patent application titled “PATIENT INFORMATION PROGRAM AND METHOD OF USE THEREOF”, Ser. No. 60/941,553, filed Jun. 1, 2007. The identified earlier-filed application is hereby incorporated by reference into the present application.

### COMPUTER PROGRAM LISTING APPENDIX

A computer program listing appendix containing the source code of a computer program that may be used with the present invention is incorporated herein by reference and appended hereto as one (1) original compact disc, and an identical copy thereof, containing a total of fifty-six (56) files as follows:

| File name | Size (Bytes) | Date of Creation |
|---|---|---|
| Form0.txt | 25 KB | Feb. 13, 2008 |
| Form1.txt | 51 KB | Feb. 13, 2008 |
| FormBilling.txt | 123 KB | Feb. 13, 2008 |
| FormConsult.txt | 29 KB | Feb. 13, 2008 |
| FormDetails.txt | 21 KB | Feb. 13, 2008 |
| FormDictate.txt | 28 KB | Feb. 13, 2008 |
| FormLB01.txt | 37 KB | Feb. 13, 2008 |
| FormLB02.txt | 21 KB | Feb. 13, 2008 |
| FormNewPt.txt | 25 KB | Feb. 13, 2008 |
| FormNotes.txt | 156 KB | Feb. 13, 2008 |
| FormOrders.txt | 22 KB | Feb. 13, 2008 |
| FormRLMP.txt | 24 KB | Feb. 13, 2008 |
| FormText.txt | 25 KB | Feb. 13, 2008 |
| Module1.txt | 82 KB | Feb. 13, 2008 |
| Form0.txt | 21 KB | Feb. 13, 2008 |
| Form1.txt | 54 KB | Feb. 13, 2008 |
| FormBilling.txt | 114 KB | Feb. 13, 2008 |
| FormConsult.txt | 27 KB | Feb. 13, 2008 |
| FormDetails.txt | 18 KB | Feb. 13, 2008 |
| FormDictate.txt | 26 KB | Feb. 13, 2008 |
| FormLBO1.txt | 34 KB | Feb. 13, 2008 |
| FormLBO2.txt | 18 KB | Feb. 13, 2008 |
| FormNewPt.txt | 23 KB | Feb. 13, 2008 |
| FormNotes.txt | 145 KB | Feb. 13, 2008 |
| FormOrders.txt | 19 KB | Feb. 13, 2008 |
| FormRLMP.txt | 21 KB | Feb. 13, 2008 |
| FormText.txt | 21 KB | Feb. 13, 2008 |
| MyPatientsV2006.txt | 78 KB | Feb. 13, 2008 |
| Form0.txt | 32 KB | Feb. 13, 2008 |
| Form1.txt | 52 KB | Feb. 13, 2008 |
| FormBilling.txt | 157 KB | Feb. 13, 2008 |
| FormDetails.txt | 22 KB | Feb. 13, 2008 |
| FormDictate.txt | 29 KB | Feb. 13, 2008 |
| FormLast.txt | 24 KB | Feb. 13, 2008 |
| FormLBO1.txt | 32 KB | Feb. 13, 2008 |
| FormLBO2.txt | 22 KB | Feb. 13, 2008 |
| FormNewPt.txt | 49 KB | Feb. 13, 2008 |
| FormNotes.txt | 187 KB | Feb. 13, 2008 |
| FormRLMP.txt | 25 KB | Feb. 13, 2008 |
| FormText.txt | 26 KB | Feb. 13, 2008 |
| FormWeightsMeasures.txt | 32 KB | Feb. 13, 2008 |
| OutPatientsDT.txt | 123 KB | Feb. 13, 2008 |
| Form0.txt | 25 KB | Feb. 13, 2008 |
| Form1.txt | 52 KB | Feb. 13, 2008 |
| FormBilling.txt | 148 KB | Feb. 13, 2008 |
| FormDetails.txt | 19 KB | Feb. 13, 2008 |
| FormDictate.txt | 26 KB | Feb. 13, 2008 |
| FormLast.txt | 21 KB | Feb. 13, 2008 |
| FormLBO1.txt | 29 KB | Feb. 13, 2008 |
| FormLBO2.txt | 19 KB | Feb. 13, 2008 |
| FormNewPt.txt | 43 KB | Feb. 13, 2008 |
| FormNotes.txt | 177 KB | Feb. 13, 2008 |
| FormRLMP.txt | 22 KB | Feb. 13, 2008 |
| FormText.txt | 22 KB | Feb. 13, 2008 |
| FormWeightsMeasures.txt | 7 KB | Feb. 13, 2008 |
| OutPatientsV2006.txt | 86 KB | Feb. 13, 2008 |

### BACKGROUND

1. Field

The present invention relates to systems and methods of documenting healthcare information. More particularly, various embodiments of the invention involve a system for enabling caregivers to quickly and easily view and record patient healthcare information in electronic form.

2. Description of Related Art

Hospitals and other medical service institutions retain records of patient information, including doctors' notes, treatment history, and so forth. To this end, hospitals use databases dedicated to maintaining and managing electronic medical records and other patient information. Such databases retain data relating to all patients, including current patients and non-current patients, and include all medical information collected for each current and non-current patient. Thus, such databases can be quite large.

Hospital information system (HIS) databases are designed to handle large quantities of data and have limited, rigid, protocols for storing and retrieving information that can be difficult and/or time-consuming to learn. Unfortunately, conventional HIS systems are not adapted for convenient, everyday use by doctors or other caregivers. For example, to submit a note to be placed in a patient's record, a caregiver may need to navigate a complex user interface that requires an understanding of the HIS protocol. Some caregivers avoid using such systems because of their complexity.

Accordingly, there is a need for an improved system for creating and storing patient information that does not suffer from the limitations of the prior art.

### SUMMARY

Embodiments of the present invention provide an improved system and method for electronic medical documentation that does not suffer from the limitations of the prior art. More particularly, embodiments of the invention involve a system for enabling caregivers to quickly and easily view and record patient healthcare information in electronic form by creating an intermediate database representing a portion of an electronic medical record database, and providing a user interface for facilitating review and modification of data stored in the intermediate database.

In particular embodiments, the system of the present invention receives a patient identifier and patient healthcare information from a user, associates the patient healthcare information with the patient identifier, and stores the patient healthcare information in the intermediate database. The system receives a command from the user and, upon receipt of the command, communicates the patient healthcare information from the intermediate database to the electronic medical record database according to a protocol that enables the electronic medical record database to store the patient healthcare information as a caregiver note in an electronic medical record pertaining to the patient identifier. The intermediate database may include patient information received from the electronic medical record database and relating only to current patients, and may be stored on a wireless handheld computing device.

The present invention enhances electronic medical documentation by making the system accessible to caregivers at each point-of-care. The system may be available, for example, via a hand-held computing device carried on the caregiver's person as he or she visits multiple patients within a building, across a medical campus, and/or across a large geographic region.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Preferred implementations of the present technology are described in detail below with reference to the attached drawing figures, wherein:

FIG. 1 illustrates an exemplary computer system operable to implement an electronic medical record document system incorporating principles of the present invention;

FIG. 2 is a block diagram of various software modules and databases associated with the present invention;

FIG. 3 is a first exemplary user interface presenting a list of patients;

FIG. 4 is a second exemplary user interface enabling a user to define the list of patients of FIG. 3 according to a category and a sub-category;

FIG. 5 is a third exemplary user interface presenting detailed information about a patient selected from the list of FIG. 3;

FIG. 6 is a fourth exemplary user interface presenting a list of note templates and incomplete notes for selection by a user;

FIG. 7 is a fifth exemplary user interface presenting a note that includes information automatically imported into the note and information submitted by a user authoring the note;

FIG. 8 is a sixth exemplary user interface presenting a note with a list of pre-existing examination terms for the user to select for inclusion in the note;

FIG. 9 is a seventh exemplary user interface presenting a note with a list of pre-existing phrases for the user to choose for inclusion in the note;

FIG. 10 is an eighth exemplary user interface presenting a note and illustrating a certain portion of text of the note highlighted for inclusion in a buffer;

FIG. 11 is a ninth exemplary user interface presenting a note and a list of text present in the buffer for the user to select for inclusion in the note; and

FIG. 12 is a tenth exemplary user interface presenting a note created for an unknown patient, wherein the note is temporarily associated with an alias in lieu of a permanent patient identifier.

### DETAILED DESCRIPTION

The following detailed description of embodiments of the present invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

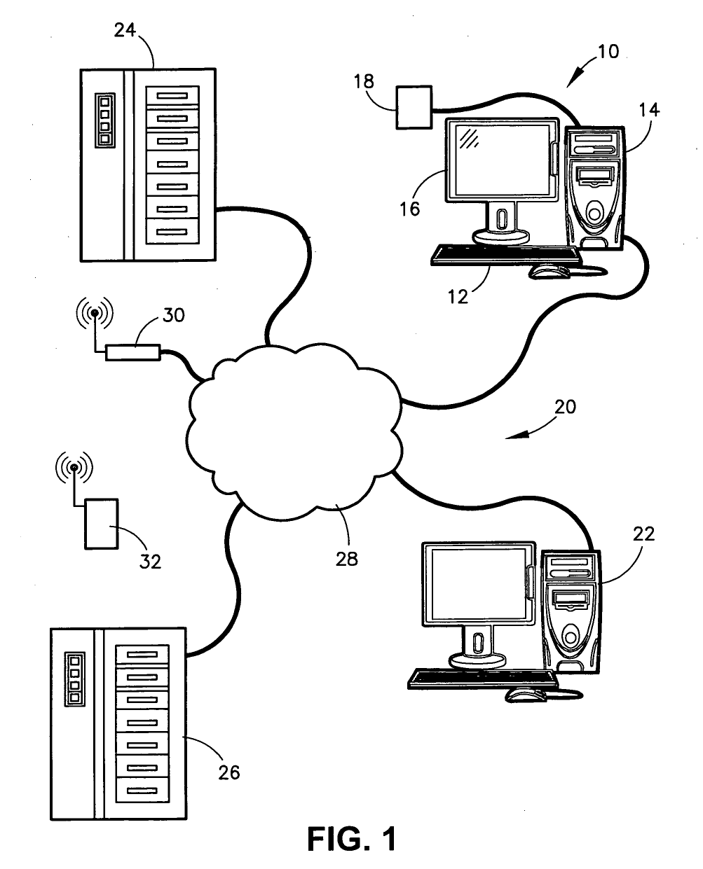

The present invention relates to a system and method of electronic medical documentation. The method of the present invention is especially well-suited for implementation on a computer or computer network, such as the computer 10 illustrated in FIG. 1 that includes a keyboard 12, a processor console 14, a display 16, and one or more peripheral devices 18, such as a scanner, printer, and/or microphone or similar audio sensor. The computer 10 may be a part of a computer network, such as the computer network 20 that includes one or more client computers 10,22 and one or more server computers 24,26 interconnected via a communications system 28. Embodiments of the present invention may also be implemented, in whole or in part, on a wireless communications system including, for example, a network-based wireless transmitter 30 and one or more wireless receiving devices, such as a hand-held computing device 32 with wireless communication capabilities. The present invention will thus be generally described herein as a computer program. It will be appreciated, however, that principles of the present invention are useful independently of a particular implementation, and that one or more of the steps described herein may be implemented without the assistance of a computing device.

The present invention can be implemented in hardware, software, firmware, or a combination thereof. In a preferred embodiment, however, the invention is implemented with a computer program. The computer program and equipment described herein are merely examples of a program and equipment that may be used to implement the invention and may be replaced with other software and computer equipment without departing from the scope of the present invention.

The computer program of the present invention is stored in or on a computer-usable medium, such as a computer-readable medium, residing on or accessible by a host computer for instructing the host computer to implement the method of the present invention as described herein. The host computer may be a server computer, such as server computer 24, or a network client computer, such as the computer 10 or the hand-held computing device 32. The computer program preferably comprises an ordered listing of executable instructions for implementing logical functions in the host computer and other computing devices coupled with the host computer. The computer program can be embodied in any computer-usable medium for use by or in connection with an instruction execution system, apparatus, or device, such as a computer-based system, processor-containing system, or other system that can fetch the instructions from the instruction execution system, apparatus, or device, and execute the instructions.

The ordered listing of executable instructions comprising the computer program of the present invention will hereinafter be referred to simply as “the program” or “the computer program.” It will be understood by those skilled in the art that the program may comprise a single list of executable instructions or two or more separate lists, and may be stored on a single computer-usable medium or multiple distinct media. The program will also be described as comprising various “code segments,” which may include one or more lists, or portions of lists, of executable instructions. Code segments may include overlapping lists of executable instructions, that is, a first code segment may include instruction lists A and B, and a second code segment may include instruction lists B and C.

As used herein, a “computer-usable medium” may be a computer readable medium or any means that can contain, store, communicate, propagate or transport the program for use by or in connection with the instruction execution system, apparatus, or device. The computer-usable medium can be, for example, but is not limited to, an electronic, magnetic, optical, electro-magnetic, infrared, or semi-conductor system, apparatus, device, or propagation medium. More specific, although not inclusive, examples of computer-usable media would include the following: an electrical connection having one or more wires, a portable computer diskette or drive including external hard drives and flash drives, a random access memory (RAM), a read-only memory (ROM), an erasable, programmable, read-only memory (EPROM or Flash memory), an optical fiber, and a portable compact disk read-only memory (CDROM). The computer-usable medium could even be paper or another suitable medium upon which the program is printed, as the program can be electronically captured, via for instance, optical scanning of the paper or other medium, then compiled, interpreted, or otherwise processed in a suitable manner, if necessary, and then stored in a computer memory.

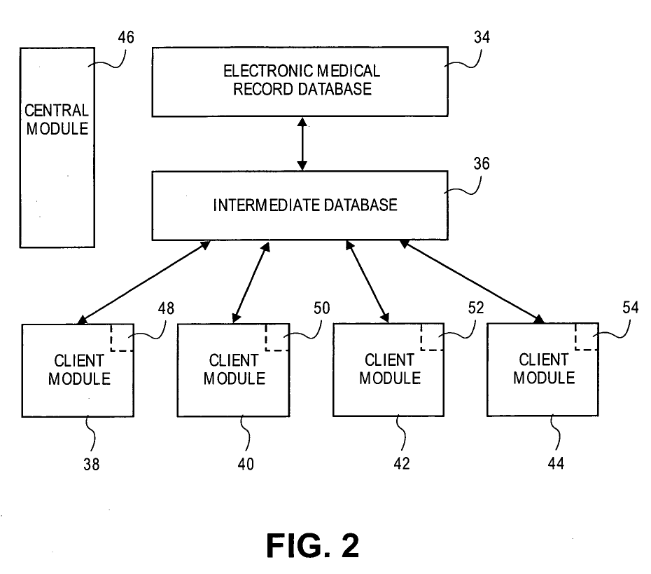

A schematic diagram of an exemplary system of various databases and software modules is illustrated in FIG. 2. An electronic medical record database 34 is in communication with an intermediate database 36. A plurality of client modules 38,40,42,44 are in communication with the intermediate database 36, and a central module 46 is in communication with or interacts with one or more of the other software modules or databases. By way of example, the electronic medical record database 34 may be implemented by the server 24, the intermediate database 36 may be implemented by the server 26, one or more of the client modules 38,40,42,44 may each be implemented on a handheld wireless device such as the device 32, and one or more of the client modules 38,40,42,44 may each be implemented on one of the client computers 14,22. It will be appreciated that any or all of the databases and software modules discussed herein may be effectively implemented on various combinations of computing devices, or even on a single computing device.

The program may be embodied in the client modules 38,40,42,44 and the central module 46, and enables communications between the electronic medical record database 34 and the intermediate database 36. The electronic medical record database 34 is a database operable to store a plurality of electronic medical records each containing a particular patient's medical information. The database 34 may be comprehensive in that it may store all patient information from both current patients and non-current patients.

As used herein, a “current patient” is a patient whose electronic medical record information is used regularly and/or frequently by a caregiver and may include, for example, patients admitted to a hospital and/or patients currently undergoing treatment. As used herein, a “non-current patient” is a patient whose electronic medical record information is not used regularly or frequently by a caregiver and may include, for example, patients released from a hospital and/or patients no longer receiving treatment.

The electronic medical record database 34 may be a pre-existing database developed by a third party, such as health information system databases developed and sold by MEDITECH™ or CERNER™. Management of the electronic medical record database may be governed by laws such as the Health Insurance Portability and Accountability Act of 1996 (“HIPAA”). The electronic medical record database 34 may be accessible via a protocol such as Health Level Seven or other messaging standard that enables disparate healthcare applications to exchange patients' personal healthcare information, including clinical and administrative data. As used herein, an “electronic medical record” is a medical record containing patient-specific healthcare information that is subject to HIPAA or similar laws.

The program is operable to enable communications between the electronic medical record database 34 and the intermediate database 36 to transfer data between the electronic medical record database 34 and the intermediate database 36. The program stores a portion of the data from the electronic medical record database 34 in the intermediate database 36, such as personal healthcare information relating only to current patients. Thus, the intermediate database 36 may be substantially smaller than the electronic medical record database 34 and may present a simplified, flexible interface that is compatible with a greater variety of preexisting computer applications.

The program is operable to identify particular data from the electronic medical record database 34 to include in the intermediate database 36. The program may store data in the intermediate database 36 relating only to current patients, as explained above. Furthermore, the program may include in the intermediate database 36 only data relating to current patient conditions and exclude data relating to some or all past patient conditions. By way of example, the program may identify patients on a list of patients as current patients, wherein the list is maintained by caregivers. Alternatively, the program may identify current patients according to data in the electronic medical record database 34, such as a data field relating to each patient indicating a current status of the patient.

The program is operable to create and maintain a plurality of instances 48,50,52,54 of the intermediate database 36, each associated with one of the client modules 38,40,42,44 and stored, for example, on computing devices associated with the client modules 38,40,42,44. The program may create each instance 48,50,52,54 to include all or a portion of the intermediate database 36, and may automatically synchronize each instance 48,50,52,54 with the data stored in the intermediate database 36.

Storing an instance of the intermediate database 36 on a device. associated with a client module is particularly helpful where, for example, a caregiver takes a handheld computing device or other computing device to a remote location where computer network communications are not available, such as where the caregiver is visiting a remote location beyond range of a wireless communications network. In such situations, the caregiver is able to view patient data stored on the handheld computing device and submit new data, such as a note. When communications are restored between the client modules and the intermediate database 36, the program updates both the instance of the intermediate database 36 stored on the handheld device and the central intermediate database 36 to reflect changes made to the other. For example, the program may add any new information received by the instance of the intermediate database stored on the handheld device to the intermediate database, and the instance of the intermediate database stored on the client device will be updated to reflect changes to the central intermediate database 36.

The program is operable to receive patient healthcare information from users and store the patient healthcare information in the intermediate database 36, to enable one or more users to access and modify the stored patient healthcare information, and store the information in the electronic medical record database when requested by the user, such as when the information is complete. When the information is stored in the intermediate database, other users with access privileges may view and/or modify the information.

By way of example, an attending physician may create a note relating to a patient and store the note in the intermediate database 36. The attending physician or other caregiver, such as a consulting physician or medical student, may view the note at a later time and add information to the note. When the note is complete, the attending physician may submit the note to the electronic medical record database 34 and sign the note.

The program is further operable to provide one or more templates for the submission of information. The program may present a list, for example, of different types of templates and enable the user to select a template from the list of templates. A template may include certain preformatted information with fields for the user to populate with information. There may be a particular template for each of various types of caregiver notes. The program may further enable users to create and/or modify templates, may provide fill information with which to populate templates, and may allow users to customize the fill information. For example, the program may provide a list of prepared words and phrases commonly used by caregivers in creating notes, such as words and phrases associated with symptoms and treatments.

The program is further operable to automatically import external information into an information template. Certain medical information relating to each patient may be gathered each day, such as weight, blood pressure, temperature, and so forth. The program may store this information in the intermediate database or otherwise access the information to import it into a particular template upon request by the user such that the template is presented to the user with the external information. Thus, information submitted by the user may be automatically supplemented by contemporaneous external information, saving the user the time required to manually submit the information.

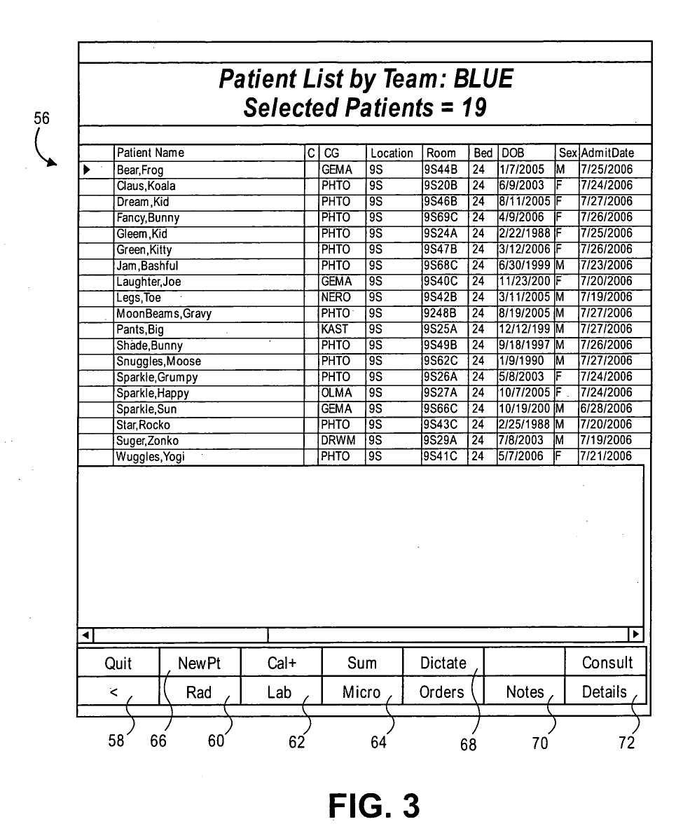

FIGS. 3-13 illustrate certain exemplary user interfaces generated by the client modules that may be employed to perform certain ones of the above-referenced functions. FIG. 3 illustrates an exemplary user interface 56 presenting a list of patients and a series of buttons. Each row in the list of patients includes various fields of information relating to the patient, including patient name or similar patient identifier, location, room number, bed number, date of birth, and date of admission to the hospital or other facility. A caregiver or other user may select one of the patients to view or may submit data pertaining to that patient, as explained below in greater detail. The interface 56 lists patients according to team, such as, for example, according to a “blue” team.

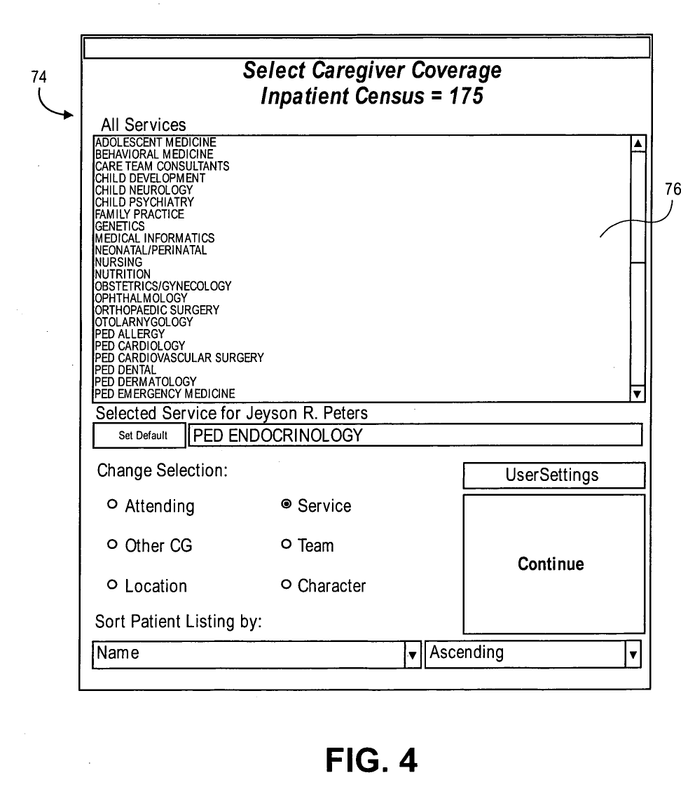

A first button 58 is a “previous screen” button that enables users to navigate to a previous user interface screen. In the interface 56, for example, selecting the button 58 will invoke the user interface screen (FIG. 4) for selecting criteria for the list of patients presented in the user interface 56. A second button 60 enables users to view radiology information for a selected patient, such as a radiology report. A third button 62 enables users to view laboratory information for a selected patient, such as a laboratory report. A fourth button 64 enables users to view microbiology information for a selected patient, such as a microbiology report for the patient. When viewing any of these reports, the user may select text from the report and store the text in a buffer to add the text to a note the user is authoring, as explained below.

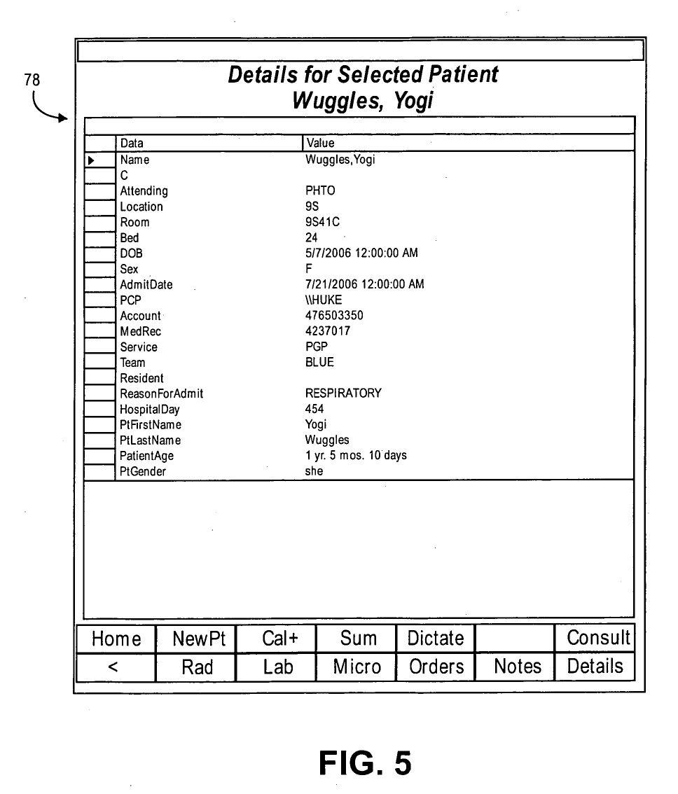

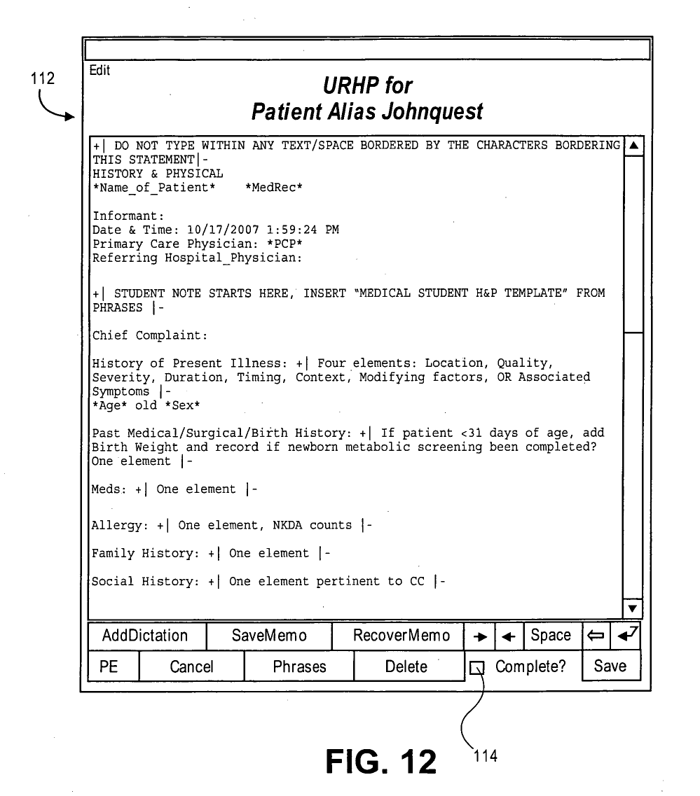

A fifth button 66 invokes a user interface screen (FIG. 12) for submitting information relating to a new patient, that is, a patient whose information is not in the electronic medical record database 34 or the intermediate database 36. The user interface screen invoked by button 66 may enable users to create a note for a new patient. A sixth button 68 enables users to create a dictation and associate the dictation with a particular patient or note. Selecting the button 68, for example, may begin a dictation for a particular patient. A seventh button 70 enables users to create, view, and/or modify notes relating to a selected patient. By way of example, the button 70 may present a listing of available note types, as well as incomplete notes relating to the selected patient. An eighth button 72 enables users to view detailed information about a selected patient, and may present a columnar list of available fields of information relating to the selected patient (FIG. 5).

In addition to the user interface buttons discussed above, a “quit” button enables a user to exit or terminate the application; a “Cal+” button presents a calendar and imports a date selected from the calendar to a field, such as a field of a note; a “Sum” button presents a summary of information relating to the selected patient, such as a list of activities and results collected over a most recent twenty-four or forty-eight hour time period; an “Orders” button presents a list of orders placed on the selected patient; and a “Consult” button presents a user interface screen that enables the user to change a list of patients for whom the user is providing consultation, including associating additional patients with the list and removing patients from the list.

FIG. 4 illustrates an exemplary user interface 74 for enabling a user to select criteria for presenting patient information in the interface 56 of FIG. 3. The user interface 74 may be invoked by selecting the button 58 or similar navigational control from the interface 56. The interface 74 may present both general and specific selection criteria. For example, the user may choose from among a list of general criteria such as attending physician, service, other caregiver, team, or location. When the user has selected a general criteria, the interface 74 presents a plurality of specific criteria. In FIG. 4, the general criteria “Service” has been selected, and a list of possible services are presented for selection in a text field 76.

FIG. 5 illustrates an exemplary user interface 78 presenting information relating to a patient selected by a user from the interface 56. The program presents the interface illustrated in FIG. 5 when the user selects a patient and selects the button 72 of the interface 56. Patient information may include name, attending physician, location, room, bed, date of birth, sex, date admitted to the hospital, and so forth.

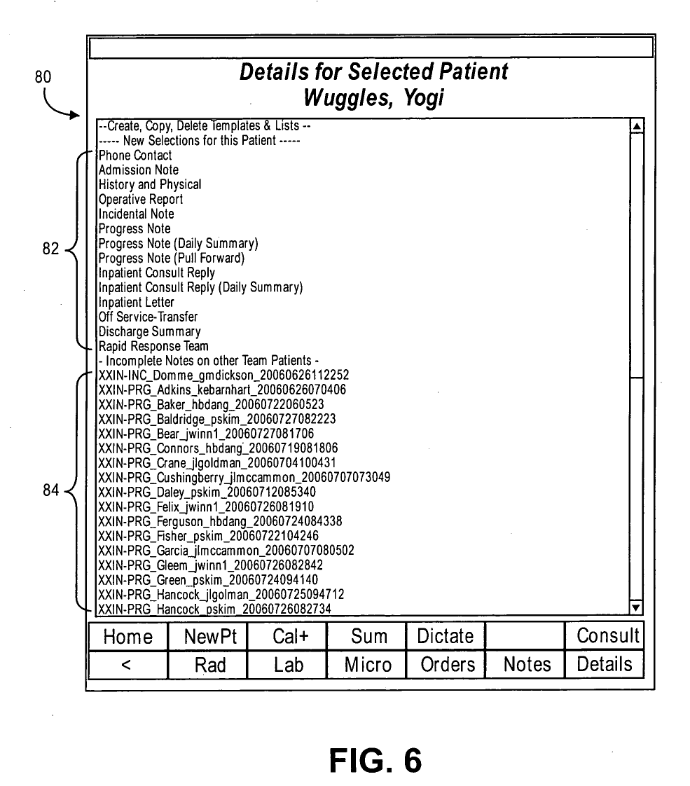

FIG. 6 illustrates an exemplary user interface 80 presenting caregiver note information that the program presents when a user selects the “Notes” button 70 of the interface 56 or other interface. The interface 80 presents a list 82 of note types for selection by the user to begin a new note for a presently-selected patient. The interface also presents a list 84 of previously-created and/or incomplete notes relating to various team patients. The user may choose to create a new note for the present patient by selecting a note type from the list 82, or may choose to view and/or modify an existing note by selecting one of the incomplete notes from the list 84. The incomplete notes represented in the list 84 may be stored in the intermediate database 36 and/or in an instance 48,50,52,54 of the intermediate database 36. When an authorized user, such as an attending physician, determines that a note is complete, he or she can submit the note to the electronic medical record database 34.

As illustrated in FIG. 6, one or more of the note types presented as part of the list 82 may be accompanied by a “pull forward” indicator, indicating that information from a previously-created note, or information otherwise previously submitted may be imported or “pulled forward” into a new note. Information thus imported may be modified by the user in the new note.

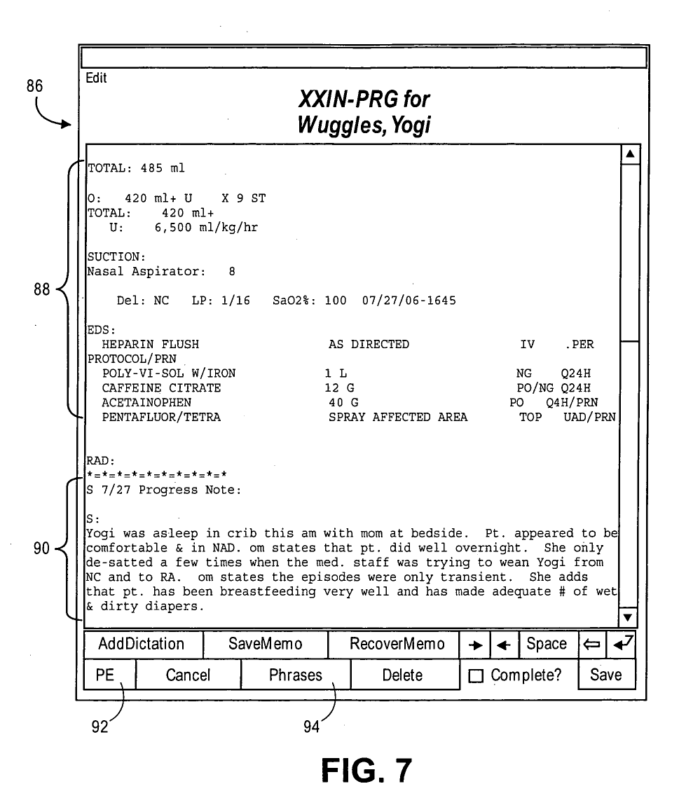

An exemplary user interface 86 presenting a new note is illustrated in FIG. 7. The note illustrated in FIG. 7 includes a first section 88 with various measured values and a second section 90 with caregiver comments. The first section 88 and the second section 90 are separated by an indicator recognized by the program, such as the text “*=*=*=*=*=*=*=*=*=*”. The program automatically imports the measured values of the section 88 into the note and places the indicator after the section 88.

The first section 88 may include information that is regularly recorded either by persons working with a patient or automatically by monitoring equipment. By way of example, the imported information of the section 88 may include observed patient conditions, such as temperature, pulse, weight, and so forth, or may include information about medication administered to the patient or other treatment information.

The button labeled “AddDictation” in the interface 86 of FIG. 7 enables the user to combine a dictated portion of a note with a written portion of the note. After completing the written portion of the note, for example, the user may select the “AddDictation” button and dictate the remainder of the note. The dictation may be created, for example, as an audio data file using a microphone or similar audio sensor associated with a handheld device, such as the device 32, a computer workstation, or other computing device. The program associates the audio file with the note, and retains the written portion of the note in the intermediate database 36 until it can be combined with a transcript of the dictation to form a complete draft of the note. The complete draft of the note (including both the original written portion of the note and the transcript of the dictation) is submitted to the electronic medical record database 34 for final editing and signature.

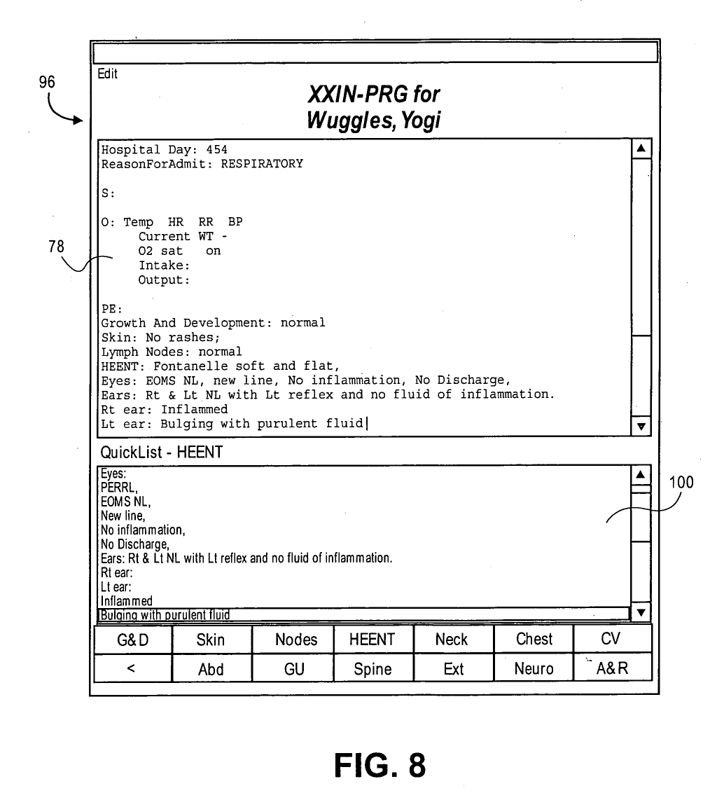

An exemplary user interface for assisting a caregiver in creating a physical exam note is illustrated in FIG. 8 that is invoked if the PE button 92 is selected in the interface 86 illustrated in FIG. 7. The caregiver may enter caregiver information by directly submitting text, such as where the caregiver types text on a keypad or a touchscreen, or by selecting pre-existing text from a list of words or phrases supplied by the program. Selecting the “Phrases” button 94 from the interface 86, for example, presents a user interface 96 with two text fields. A first text field 78 presents the note in progress, while a second text field 100 presents a list of words, phrases or other text available to the caregiver.

The caregiver can choose between various categories of phrases by selecting among various buttons presented at the bottom of the interface 96. When the user selects one of the phrases listed in the second text field 100, the program adds the phrase to the note in progress in the first text field 98 in a location identified, for example, by a cursor or similar position indicator. By way of example, the text “Lt ear” and“Bulging with purulent fluid” were selected from the second text field 100, and appear in the note at the bottom of the first text field 98. In some cases, a caregiver may create an entire note by selecting various words and phrases from the second text field 100.

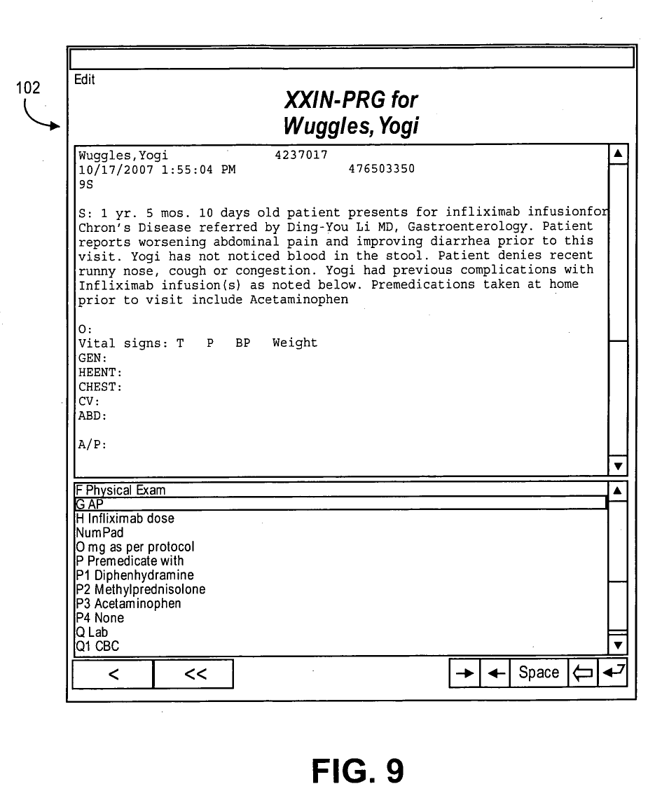

FIG. 9 illustrates an exemplary user interface 102 that is similar to the interface 96 described above, except that the interface 102 presents list of phrases that may be presented with the caregiver selects the “Phrases” button of the interface screen of FIG. 7. The selectable phrases presented in the interface 102 may include phrases used frequently by caregivers, and the list of phrases may be modified by the caregiver.

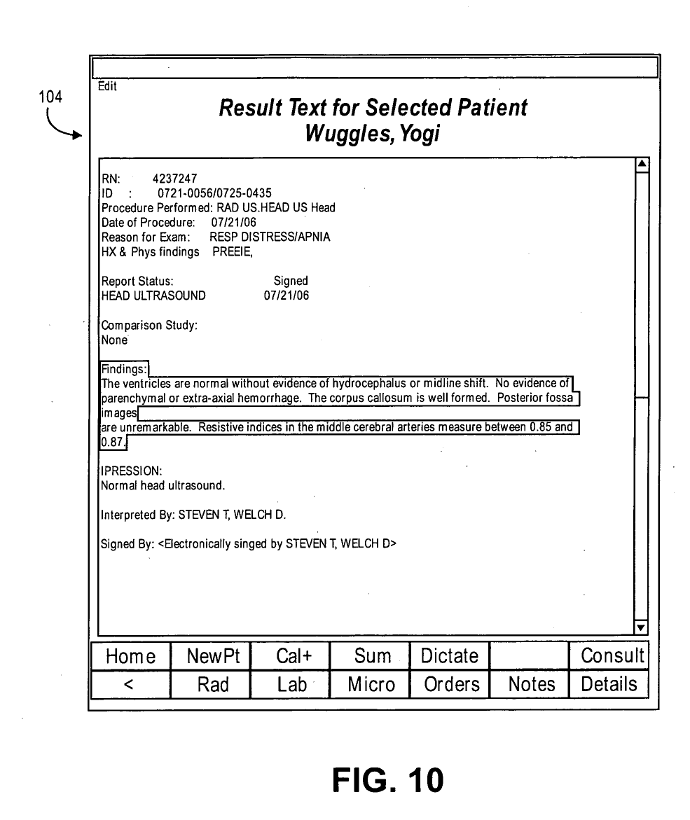

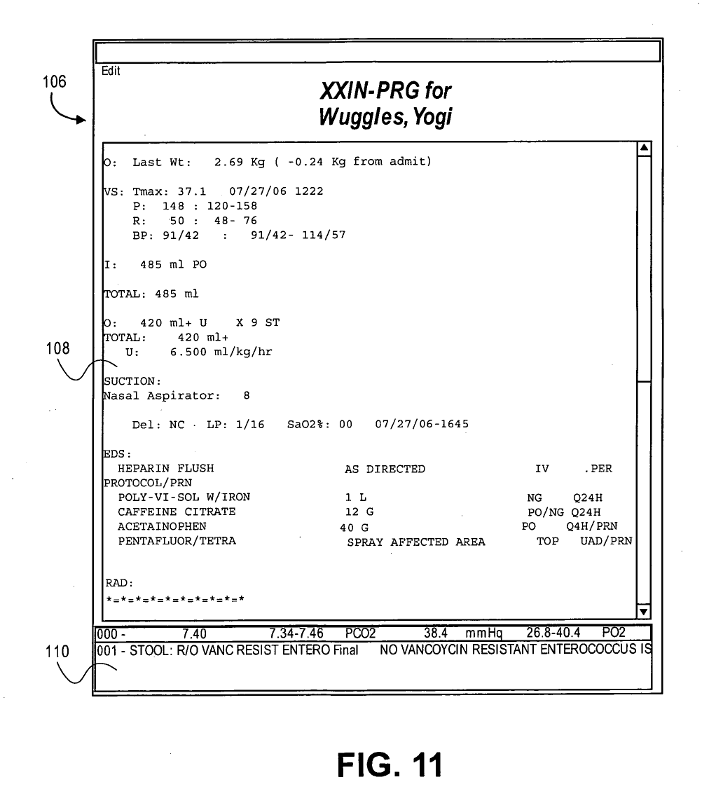

FIG. 10 illustrates a note with text selected by the user presented in a highlighted form. The program enables users to select any text from any note or report and to copy the selected text to an electronic buffer or “clipboard” for use in another note. FIG. 11 illustrates user interface 106 with a top portion 108 presenting a note in progress, and a lower portion 110 presenting items previously stored in the electronic buffer. To add an item from the electronic buffer to the note in progress, the user selects the desired item. The lower portion 110 may present various distinct items each stored in the electronic buffer at different times and from different sources.

FIG. 12 illustrates an exemplary template 112 presented by the program when the user selects the “NewPt” button 66 of the interface 56. The template 112 may be invoked, for example, when a caregiver is working with a new patient with no information in the electronic medical record database 34 or the intermediate database 36. The template 112 uses a temporary patient alias or similar identifier to associate the template with the new patient. This may be necessary, for example, where the patient's name is not known.

By using a temporary patient alias in the template 112, the caregiver is able to immediately begin recording information about the new patient without waiting for a new electronic medical record to be created for the new patient in the electronic medical record database 34, and may even begin recording information about the new patient before the new patient's personal information is submitted to the electronic medical record database 34 or to the intermediate database 36. The program retains information submitted to the template 112 until sufficient patient information is obtained to create an electronic medical record for the patient in the electronic medical record database 34.

The template 112 illustrates various tokens that the program uses to automatically import information into the template. The tokens are delineated by asterisks, and include “*Name_of_Patient*”, “*MedRec*”, “*PCP*”, “*Age*”, and “*Sex*”. Other tokens may include “AdmitDate,” “User”, “UserTitle”, and so forth. When opening a template, the program identifies the tokens and replaces each token with corresponding information from the intermediate database (if the information is available). The user may choose which tokens to include in any user-defined template, giving the user the flexibility to create note templates that import virtually any combination of existing patient information.

The program may present a checkbox 114 for indicating if a note is complete. If a user selects the checkbox 114, the program removes the note from the list of incomplete notes 84 and submits the note to the electronic medical record database 34 for a final signature by an authorized caregiver, such as an attending physician.

Although embodiments of the present invention have been described with reference to the attached drawings, it is noted that equivalents may be employed and substitutions made herein without departing from the scope of the subject matter recited in the claims. It will be appreciated, for example, that the central module 46 and/or any of the client modules 38,40,42,44 may be integral with either the electronic medical record database 34 or the intermediate database 36.

Having thus described preferred implementations of the present technology, what is claimed as new and desired to be protected by Letters Patent includes the following:

1. A computer useable medium encoded with a computer program for enabling electronic healthcare documentation, said program comprising:
a code segment for receiving a patient identifier and first patient healthcare information from a first user, associating said first patient healthcare information with said patient identifier, and storing said first patient healthcare information in an intermediate database; and
a code segment for receiving a command from said first user and, upon receipt of said command, communicating said first patient healthcare information from said intermediate database to an electronic medical record database according to a protocol that enables said electronic medical record database to store said first patient healthcare information in an electronic medical record pertaining to said patient identifier as a caregiver note.

2. The computer useable medium as set forth in claim 1, said computer program further comprising a code segment for presenting a list of patient identifiers to said first user and enabling said first user to select said patient identifier from said list of patient identifiers.

3. The computer useable medium as set forth in claim 2, said computer program further comprising a code segment for requesting said list of patient identifiers from said electronic medical record database, wherein said list of patient identifiers relates only to current patients.

4. The computer useable medium as set forth in claim 1, said computer program further comprising a code segment for identifying said first user as a caregiver authorized to submit healthcare information to said electronic medical record associated with said selected patient.

5. The computer useable medium as set forth in claim 1, said computer program further comprising a code segment for enabling a second user to view said first patient healthcare information and for receiving second patient healthcare information from said second user.

6. The computer useable medium as set forth in claim 5, said computer program further comprising a code segment for storing said first patient healthcare information and said second patient healthcare information in said intermediate database such that said first patient identifier is associated with said first patient healthcare information and said second patient healthcare information.

7. The computer program as set forth in claim 6, further comprising a code segment for identifying said second user as a caregiver authorized to submit healthcare information to said electronic medical record associated with said selected patient.

8. The computer useable medium as set forth in claim 6, said computer program further comprising a code segment for communicating said first patient healthcare information and said second patient healthcare information to said electronic medical record database according to a protocol that enables said electronic medical record database to store said first patient healthcare information and said second patient healthcare information in said electronic medical record pertaining to said selected patient as a single caregiver note.

9. The computer useable medium as set forth in claim 1, said computer program further comprising a code segment for receiving an audio data file and associating said audio file with said first patient healthcare information and said patient identifier.

10. The computer useable medium as set forth in claim 1, said computer program further comprising
a code segment for receiving second patient healthcare information and a temporary patient identifier indicating a new patient;
a code segment for storing said second healthcare information in said intermediate database associated with said temporary patient identifier;
a code segment for receiving identification information relating to said new patient and associating said second patient healthcare information with said identification information; and
communicating said second patient healthcare information and said identification information to said electronic medical record database as a new electronic medical record.

11. A computer useable medium encoded with a computer program for enabling electronic healthcare documentation, said program comprising:
a code segment for enabling a caregiver to create one or more user-defined note templates, said one or more user-defined note templates each defining an information structure;
a code segment for presenting a list of patient identifiers and a list of note templates to said caregiver, said list of note templates including said one or more user-defined note templates and at least one pre-defined note template;
a code segment for receiving from said caregiver a first patient identifier selected from said list of patient identifiers and first patient information;
a code segment for adding said first patient information to a note template selected from said list of note templates by said user;
a code segment for storing said template in an intermediate database, wherein said template includes said first patient information and is associated with said first patient identifier;
a code segment for enabling a second caregiver to view said template and said first patient information and to submit second patient information;
a code segment for adding said second patient information to said template and storing said template in said intermediate database with said first patient information and said second patient information; and
a code segment for communicating said first patient information and said second patient information to an electronic medical record database according to a protocol that enables said electronic medical record database to store said first patient information and said second patient information as a single caregiver note in an electronic medical record associated with said first patient identifier.

12. The computer useable medium as set forth in claim 11, said computer program further comprising a code segment for presenting a list of phrases to said caregiver and adding a phrase selected from said list of phrases by said first caregiver to said selected note template as part of said first patient information.

13. The computer useable medium as set forth in claim 12, said computer program further comprising a code segment for enabling said caregiver to submit one or more phrases and to include said one or more phrases in said list of phrases.

14. The computer useable medium as set forth in claim 11, said program further comprising
a code segment for enabling said caregiver to selectively include one or more tokens in each of said one or more user-defined note templates; and
a code segment for identifying said one or more tokens in said note template selected from said list of note templates by said user if said selected template is one of said user-defined note templates, and replacing said one or more tokens with information from said intermediate database corresponding to said first patient identifier.

15. A computer useable medium encoded with a computer program for enabling electronic healthcare documentation, said program comprising:
a code segment for enabling a handheld computing device to receive patient data from a wireless communications interface, wherein said patient data represents a portion of data from an electronic medical record database;
a code segment for enabling said handheld computing device to present a list of patient identifiers to a user, wherein each patient identifier of said list of patient identifiers represents a patient whose information is included in said patient data;
a code segment for enabling said handheld computing device to receive patient information from said user, to enable said user to select a patient identifier from said list of patient identifiers, and to update a portion of said patient data relating to said patient identifier to include said patient information; and
a code segment for enabling said handheld computing device to communicate at least part of said patient data to said wireless communications interface, wherein said at least part of said patient data includes said patient information received from said caregiver.

16. The computer useable medium as set forth in claim 15, said computer program further comprising a code segment for arranging said patient information into a caregiver note structure recognizable by an electronic medical record database.

17. The computer useable medium as set forth in claim 15, said computer program further comprising a code segment for identifying said user as a caregiver authorized to submit said patient information to said patient data.

18. The computer useable medium as set forth in claim 15, said computer program further comprising a code segment for presenting a list of note templates to said user and for enabling said user to select one of said note templates.

19. The computer useable medium as set forth in claim 15, said computer program further comprising a code segment for enabling said user to create a user-defined note template, wherein said user-defined note template defines an information structure, and wherein said note template is presented to said user as part of said list of note templates.

20. The computer useable medium as set forth in claim 19, said computer program further comprising a code segment for presenting a list of phrases to said first user and adding a phrase from said list of phrases to a note template selected by said user as part of said first patient information.

21. The computer useable medium as set forth in claim 15, wherein management of said patient data is governed by the Health Insurance Portability and Accountability Act of 1996.

22. A computer useable medium encoded with a computer program for enabling electronic healthcare documentation, said program comprising:
a code segment for receiving patient data from an electronic medical record database interface;
a code segment for communicating at least a part of said patient data to a wireless interface;
a code segment for receiving from said wireless interface updated patient data and updating said intermediate database to include said updated patient data; and
a code segment for communicating at least a portion of said intermediate database to said electronic medical record database.

23. The computer useable medium as set forth in claim 22, said computer program further comprising a code segment for generating a request for said patient data and communicating said request to said electronic medical record interface, wherein said request is in a form compatible with a protocol of said electronic medical record database.

24. The computer useable medium as set forth in claim 22, wherein said patient data includes only data relating to current patients.

25. A system for enabling electronic healthcare documentation, said system comprising:
an electronic medical record database;
an intermediate database;
a handheld computing device in wireless communication with said intermediate database; and
a computer program for
identifying information in said electronic medical record database relating to current patients, and for storing said information in said intermediate database,
enabling said handheld wireless device to receive and locally store an instance of said intermediate database,
enabling said handheld wireless device to present a list of patient identifiers to a first user, wherein each patient identifier of said list of patient identifiers represents a patient whose information is included in said instance of said intermediate database,
receiving from said first user a selected patient identifier selected from said list of patient identifiers and first patient healthcare information, associating said first patient healthcare information with said selected patient identifier, and storing said first patient healthcare information in said intermediate database, and
receiving a command from said first user and, upon receipt of said command, communicating said first patient healthcare information from said intermediate database to said electronic medical record database according to a protocol that enables said electronic medical record database to store said first patient healthcare information as a caregiver note in an electronic medical record pertaining to said selected patient identifier.

26. The system as set forth in claim 25, said computer program further comprising a code segment for enabling a second user to view said first patient healthcare information and for receiving second patient healthcare information from said second user.

27. The system as set forth in claim 25, said computer program further comprising a code segment for storing said first patient healthcare information and said second patient healthcare information in said intermediate database such that said selected patient identifier is associated with said first patient healthcare information and said second patient healthcare information.

28. The system as set forth in claim 27, further comprising a code segment for identifying said second user as a caregiver authorized to submit healthcare information to said electronic medical record associated with said selected patient.

29. The system as set forth in claim 27, said computer program further comprising a code segment for communicating said first patient healthcare information and said second patient healthcare information to an electronic medical record database according to a protocol that enables said electronic medical record database to store said first patient healthcare information and said second patient healthcare information in an electronic medical record pertaining to said selected patient.
